(19) United States
(12) Patent Application Publication
(10) Pub. No.: US 2012/0226592 A1
(43) Pub. Date: Sep. 6, 2012

(54) Approach For Producing And Managing Electricity

(76) Inventor: Michael P. Flynn, Rancho Santa Fe, CA (US)

(21) Appl. No.: 13/410,138

(22) Filed: Mar. 1, 2012

Related U.S. Application Data
(60) Provisional application No. 61/448,158, filed on Mar. 1, 2011.

(51) Int. Cl. G06Q 30/04

(52) U.S. Cl. 705/34

(57) ABSTRACT

An approach for producing and managing electricity includes producing electricity off premise while providing offsetting of power consumed on premise. As used herein, the term “off premise” refers to a location other than the location where electricity is being consumed and the term “on premise” refers to the location where the electricity is being consumed. The approach is applicable to any method or technology for generating electricity. Participants or customers have an ownership interest in the power generating facility. The offsetting of power may be accomplished using a wide variety of techniques, for example, energy production data may be reported to the premise where electricity is consumed and/or to an electric utility company to allow for customer billing credits, adjustments and/or direct or in-direct utility meter off-sets (net metering). Thus, each participant produces the power they consume with electricity production equipment in which they have an ownership interest.

### RELATED APPLICATION AND CLAIM OF PRIORITY

This application claims the benefit of U.S. Provisional Application No. 61/448,158 (Attorney Docket No. 60253-0011) entitled APPROACH FOR PRODUCING AND MANAGING ELECTRICITY, filed Mar. 1, 2011, the entire contents of which is hereby incorporated by reference as if fully set forth herein for all purposes.

### FIELD OF THE INVENTION

The present invention relates to the production and management of electricity.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Today many customers who would like to generate their own electricity are limited by many factors, including insufficient initial capital, aesthetic concerns and location limitations, e.g., insufficient wind or insufficient space or improper orientation for solar. In addition, customers who are tenants or owners of certain types of property interests, for example condominiums, may be legally prohibited from installing infrastructure to generate electricity.

### BRIEF DESCRIPTION OF THE DRAWINGS

FIG. 1 depicts an example solar installation in which the energy production facility is located at the customer's premise with net metering.

FIG. 2 depicts an approach for having customers' electricity production located off-premise and connected to the electric utility company's distribution network.

FIG. 3 depicts example contents of a SolarFarm.

FIG. 4 depicts an example embodiment of the SolarFarm method.

FIGS. 5A & 5B depict an approach for reporting energy production data to an electric utility company's data/billing system and/or the customer's premise (or both) via the Internet and/or over BPL technology (Broadband over Power Lines).

FIG. 6 depicts two example BPL methods for connecting the SolarFarm an electric utility company and/or customer premise.

FIG. 7 depicts an example modular implementation of the SolarFarm facility.

FIG. 8 depicts how individual users own a portion of a SolarFarm.

FIG. 9 depicts an example participation structure as a percentage of an energy production facility.

FIG. 10 depicts the placement of SolarFarm energy production facilities in various locations located in close proximity to the customer and further away from the customer premises where electricity is consumed.

FIG. 11 is a block diagram of a computer system on which embodiments of the invention may be implemented.

### DETAILED DESCRIPTION

An approach for producing and managing electricity includes producing electricity off premise while providing offsetting of power consumed on premise. As used herein, the term “off premise” refers to a location other than the location where electricity is being consumed and the term “on premise” refers to the location where the electricity is being consumed. The approach is applicable to any method or technology for generating electricity. Examples include, without limitation, solar, wind, hydroelectric, natural gas and fossil fuel electricity generation technologies. According to the approach, participants or customers have an ownership interest in the power generating facility. The offsetting of power may be accomplished using a wide variety of techniques that are described in more detail hereinafter. For example, energy production data may be reported to the premise where electricity is consumed and/or to an electric utility company to allow for customer billing credits, adjustments and/or direct or in-direct utility meter off-sets (net metering). This approach does not use a conventional power plant. Rather, each participant produces the power they consume with electricity production equipment in which they have an ownership interest. The barrier to entry for off-site power production is the power utility's viewing any off-site power production as a power electricity plant. This method overcomes this hurdle and makes this method of customer power production off-site a realistic business method. Features of the approach include:
Each customer owns their energy production facility that can be changed or removed without affecting other customers.
Each customer can increase or decrease the capacity of their energy production facility and may also sell infrastructure from their energy production facility.
Each customer's power production is sent to the electric utility and/or the customers premise for direct off-setting against power used by that individual customer.
Home owner associations or other commonly owned land/buildings provide justification that each customer has an ownership interest in their energy production facility that is not part of a power utility plant, since within these associations, every customer is an owner of the association as well as their premise.
Each customer's energy production facility may be developed at or near cost.
Customers own their energy production facilities with little to no upfront cost.
Customers may be charged at their current electric utility rate for equipment/installation cost recovery. After cost recovery, the customer may be charged a nominal rate for rent, maintenance, etc.
Inverters are sized to each energy (solar/wind) module or each customer's energy production facility, thus electric utility gets energy production data that indicates the exact energy production for each customer. Each location utilized by each customer has a meter and/or electric distribution, disconnect, breaker box, etc., for connection to the electric grid.
A device and/or module is located at each customer's premise to report energy production data. The device and/or module may be connected to the electric utilities smart meter at the customer's premise of use to “act” as if the energy production facility is located on customer's premise.
Connections to the utility grid at the place of energy delivery to common ownership parcels, i.e. Home Owner Associations, Master Planned Communities, PUD's, etc., puts produced power on the grid at the place it enters the parcel, thus the existing grid is sufficient to transport produced electricity. The parcel is just “pulling” less power into the parcel because of a direct/exact off-set of power produced at the location where the power is consumed at the customer premise.
Placement of energy generating facilities within HOAs, master planned communities, PUDs, etc., allows electricity production to be distributed from the serving electric utility company at the circuit “demark” of the development, often within the infrastructure and delivered and paid for by the community and/or parcel owners.

The approach includes a method of providing residential, business, commercial, governmental & public entities, referred to as “customers,” the opportunity to participate in generating their own renewable energy by utilizing off-premise locations for placement of solar, wind and other means of electricity production. The approach described herein allows individual customers the ability to generate electricity for their own use using an off premise energy production facility. The approach lowers the cost of each customer's energy production facility relative to conventional renewable energy installations, since the approach provides economies of scale. With the current approach, each customer installation is not unique, thus allowing for “plug and play” infrastructure deployment and scalability of each customer's energy facility with monetization of each customers assets.

This approach includes the use of off-premise energy production facilities, referred to herein as “SolarFarms” that allow many customers who would not otherwise be able to generate their own energy participate in energy production, regardless of how small or large their individual energy needs. SolarFarm utilizes large off-premise energy production facilities that are owned by multiple customers. Customers own their own energy production capacity by acquiring the energy producing facilities, e.g., photovoltaic modules, wind turbine modules, etc., with either a land lease, or by acquiring the property on which their energy production facilities are located within the SolarFarm. Customers may also lease their energy production equipment/facilities for a specified cost based on the size and/or production capacity of the energy production equipment/facilities. The cost may be determined, for example, based upon the particular type of energy generating equipment used, e.g., per photovoltaic module, wind turbine, etc. Alternatively, the cost may be determined based upon the amount of energy consumed, e.g., by the KWh produced from their individually-owned infrastructure. This is distinguished from owning a percentage of a power plant, in which the compensation for power production is set at the rate the electric utility is paying for power produced and supplied to their system.

The SolarFarm method is a means by which all electricity users can own their energy production facility without many of the limitations that exist today with on-premise energy production. This method reduces the cost of energy production facilities, provides faster cost recovery, provides increased electricity production, easier maintenance (i.e. cleaning the photovoltaic modules) and allows placement of energy production facilities in areas that are best suited for each type of renewable energy production technology.

The approach may be implemented using a wide variety of hardware components and/or software applications for reporting the production of each customer's energy production facility to the local electric utility company serving that territory and the invention is not limited to any particular hardware components and/or software applications. Example implementations are described in more detail hereinafter. Each customer energy facility reports the amount of electricity production in a form and format required by the serving electric utility company to one or more of their data collection points. Example data collection points include, without limitation, an electric utility company's billing system or data center, the electric utility company meter at the customer's premise or place of business and an additional data collection device located adjacent to and connected to the electric utility company's meter to allow electricity usage off-setting, commonly referred to as net metering or “side by side” readings/display of each customer's energy production. Each customer's SolarFarm production data may be sent to the electric utility company's data/billing center for future off-setting of the end customer's on-site electric usage and/or associated charge. One of the goals of the approach described herein is to ensure that each customer's power production reported to the electric utility qualifies under existing electric tariffs for “net metering” treatment and avoids customers being classified as power plant producers. Thus, customer electricity usage may be offset at the point of consumption, i.e., at a customer's home, or at the electric utility company.

Alternatively, customers may be given a credit on their bills that corresponds to their ownership in a SolarFarm. The credit may be implemented in different ways, depending upon a particular implementation. For example, customers may be given a credit on their bill that reflects their share of the amount of power generated and provided to a utility company by a SolarFarm. So, if a particular customer has a 10% interest in a particular SolarFarm, the particular customer is given a credit on their bill that reflects the value of 10% of the electricity generated and provided by the particular SolarFarm to the utility company. The value of the particular customer's portion of the electricity generated by the SolarFarm may be determined using the rates paid by the particular customer or at other rates, for example at a feed-in tariff rate.

The data sent to data collection points may include a wide variety of data that may vary depending upon a particular implementation and the approach described herein is not limited to any particular type or format of data. Example of data sent to data collection points includes, without limitation, power (Kwh) produced and supplied to the grid, over time. The data may include other data required by a serving electric utility to ensure that customers of SolarFarm obtain a direct off-set against their power use based on the rates/tariffs being applied by the electric utility. The use of modules and/or customer-specific inverters allows the electric utility to quantify each customer's own energy production, just as if their energy production facility was at their premise of use. This method may include the use of a separate meter and/or power distribution “box” at each customer's premise to create the structure favorable to gaining regulatory and electric utility agreements for off-premise power production and customer electric use off-setting.

One of the benefits of the approach described herein is the ability for customers to dynamically change their energy production over time. This is accomplished by the SolarFarm “plug and play” method of giving customers the ability to dynamically increase or decrease their production capacity without all of the difficulties in changing the production capacity of a conventional on-premise installation. In addition, the approach provides portability by allowing customers to remove their energy producing facility infrastructure and relocate the infrastructure if, for example, they move from one region served by one electric utility company to another region served by a different electric utility company. This is important due to the fact that customer budgets change; tax incentives and rebates may not be available or at the same level as today. The approach also allows customers to monetize their investment, which provides the flexibility in the future to sell all or part of their energy production facility, something today's on-premise method of individual systems does not offer.

This method allows customers to get the benefit of off-setting their own electric usage as provided by the electric utility company rates just as if their energy production facility was located at their premise. The customer is not acting as a power provider and/or utility, which allows the customer to produce the same amount of energy that they use, much in the same manner as if they had sized their energy production plant at their primary premise location. The ability to off-set power produced against power consumed by “matching” the credit for energy production against the power consumed allows SolarFarm customers equal access to owning their own renewable energy facility and the ability to recover their investment in a timely manner. This is preferable to being paid a much lesser amount for energy produced and supplied to the electric utility company as if their facility was an electric utility production plant receiving a nominal per KWh rate paid by the electric utility company for electricity production. The customers of SolarFarm are only producing, as close as possible, the power consumed by their own premise energy usage. Customers are not selling electricity as if they were an electricity power production plant. The introduction and deployment of Smart Meters allows easier reporting of each customer's energy production into the electric utility company's meter for direct off-setting against power consumed since the Smart Meters are electronic and not mechanical in their detection of electric current in and out of the meter.

SolarFarm energy production infrastructure may be placed at a wide variety of off-premise locations. Example locations include, without limitation, commercial/retail roof tops, municipal lands, landfills and remote areas, such as the desert. Placement of SolarFarm facilities closer to customer premises allows power to be fed into the electric utility company grid at or near the location where power is provided to customer premises. The use of home owner association land and/or utility easements within associations and/or master planned communities is an example of how SolarFarm solves many of the road blocks in place today. For example, home owner associations can now generate revenue for association budgets, while providing a true service to their home owners and businesses. The home owners and businesses not only benefit from the lower cost of owning and operating their energy production facility, but as a direct benefit from the home owners association receiving revenue, the association dues can be reduced and/or supplemented to better the community. The same holds true for cities, who for example can use various land, such as water district, parks, etc., to supplement their budgets, commercial centers and even large master planned communities with numerous individual home owner associations, businesses and the like.

In the home owner association context, each home owner in the association is an actual owner of the association. The percentage of ownership may be based upon a variety of factors, such as the number of residences within the association, the size and types of homes. For example, some large developments that include condominiums and single family homes may specify different ownership interests for the condominiums and single family homes. Thus, the home owners own energy generating facilities located anywhere on the land owned by the association. This approach avoids potential problems associated with shared energy generating facilities located on property not owned by the association (and the homeowners). In addition, placement of the energy production on association property locates the power production close to the points of power consumption.

According to one embodiment of the invention, the approach includes the use of various financing options and business structures. One example includes the establishment of a parent company, SolarFarm, Inc. that owns a plurality of franchises. This would allow small businesses to be established under the various SBA Loan Programs at very favorable rates. In this method, the new franchisee borrows the funds to develop a SolarFarm establishment, which would include land acquisition, equipment or both. The new franchisee would then have enough infrastructures for a number of SolarFarm energy customers to locate/own their facilities within that franchise territory and be able to provide favorable financing of customers' energy production facilities. Depending on the cost of funds available to the franchisee, the payments from the energy customer may be fixed per energy producing module, for example, per photovoltaic module “panel”, wind turbine or other energy production equipment/infrastructure. SolarFarm can also act solely and/or manage of facilities with the individual customer purchasing and/or leasing their own facility placed within the SolarFarm development. Under this scenario, customers of SolarFarm may purchase and/or lease their equipment from various solar installation companies in each marketplace, basically acting as a landlord supplying the land directly or through the use of home owner association and other lands and/or buildings.

With this approach, SolarFarm may participate in the marketing and use the development expertise of existing solar installers. SolarFarm would supply the land and the connectivity to the electric grid. SolarFarm then has very little to no capital cost in developing SolarFarms. Each customer develops their own facility under the guidelines established by SolarFarm and its partners (the underlying building and/or land owners). This method opens up the renewable energy business to many underserved business owner classifications, as well as provides the means for other citizens and organizations with limited capital to participate in energy independence and economic growth.

The approach described herein may also incorporate a method to further reduce the cost of renewable power for its customers via a method for passing through to customers the depreciation expense savings it would receive by incorporating a solar lease program. Solar leases exist today, yet the end customer does not truly become energy independent and may not even receive the true benefits of allowable depreciation expense against income, since residential customers are precluded under tax laws from depreciation deductions.

Under the SolarFarm lease method, end customers establish their leased facilities within the SolarFarm development and are charged a per-KwH rate for power production, (based on their infrastructure output of electricity) either at a reduced rate and/or at their existing electric utility tariff rate. For example, a customer may be charged current rates until capital costs are recovered, followed by lower rates. An example would be a decrease in rate from 25 cents per KwH during capital recovery (matching costs per KwH of the serving electric utility tariff rate) to 5 cents per KwH to cover equipment maintenance and/or incorporate the ground/building lease rate SolarFarm is charging for hosting the end customer energy production facility. A software application may be employed to calculate the amount charged to customers at any point in time.

Conventional solar leases often do not allow energy independence when compared to customer owned facilities, since they are for substantial periods of time, for example some are 20 years with annual cost escalations. In addition, the customer's options at the end of the lease are usually limited to renewing at the new rates, removing the equipment or purchasing the equipment they in essence have already paid for. The ability to pay off the cost and then receive substantial savings under the existing models are not feasible and the end customer pays substantially more than the cost of equipment and installation when considering the financial terms of the existing solar leases. Yet, solar leases do allow customers to participate with little to no money down for their facility. According to the approach described herein, SolarFarm supplies home owner association developments a list of approved solar installer companies offering direct purchase and/or solar leases to the community participants to choose from, creating an environment of open bidding to lower the cost for customers and assure the SolarFarm development meets the goals of the community members.

According to the approach described herein, energy customers may participate in producing electricity with wind, something that has been mainly limited to large wind turbine developments. The ability to place a small wind turbine at a residence, business, commercial, municipality or government location has been thwarted by environmental constraints, such as lack of adequate wind, or other constraints, such as local zoning laws. This approach allows customers to have an ownership interest in large wind turbine facilities located in areas that are suitable for generating electricity from wind. Electricity generation from wind in some cases is more economical from a cost basis then solar.

The approach may also incorporate a method for developing land tracts for future lot sales. In this method, the SolarFarm uses individual power connections/distribution panels and/or on-site electric meters for each customer's energy production. With this method, the energy producing infrastructure is determined based on a specified lot size. The lot size may be determined, for example, based upon the energy production of the customers. For example, a large tract of land may be subdivided into individual lots, suitable for a future housing, trailer park or commercial use where the ability to subdivide and sell the improved lots increases the value of said land. As an example, a 100 acre parcel may be subdivided into 10,000 square foot lots during the use of the land as an energy farm. At a point in the future, when economic conditions warrant the sale or other use of the land, the energy farm may be relocated to another larger parcel of land and the process repeated. This method allows remote land locations today in the path of new development (homes, mobile home parks, etc.) to increase in value substantially, as well as create an interim revenue source to both the land owner and SolarFarm. Customers receive a credit and/or have SolarFarm compensate them for electric use during the transition of the customer's energy production facility to a new location.

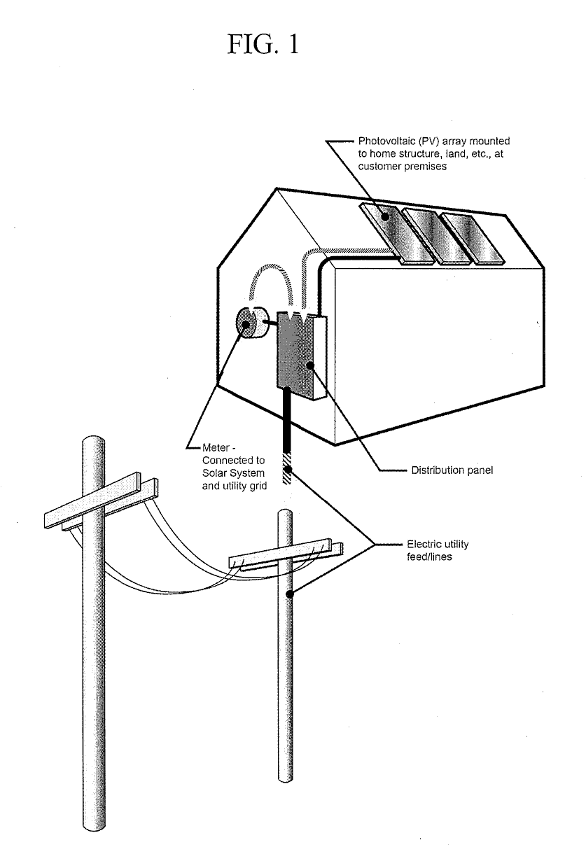

FIG. 1 depicts an example solar installation in which the energy production facility is located at the customer's premise with net metering, allowing the customer to off-set their electricity purchased from an electric utility company with electricity generated by the customer's solar installation. The customer's solar installation is directly connected to the electric utility company meter to provide direct off-setting of power consumed.

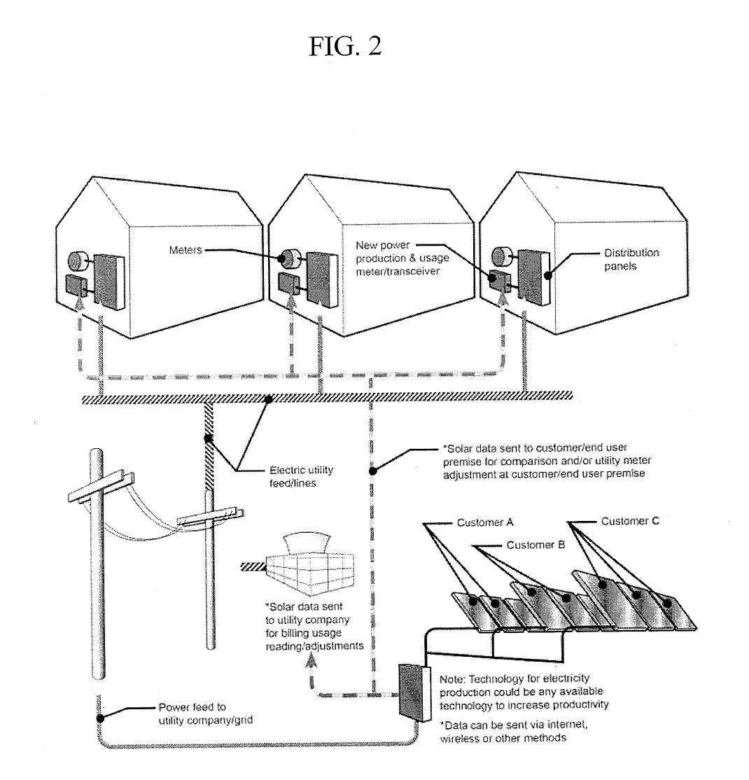

FIG. 2 depicts an approach for having customers' electricity production located off-premise and connected to the electric utility company's distribution network (which can be low or high voltage connection depending on where SolarFarm is located within the electric utility company's power distribution grid). Data specifying the energy production for each customer is transmitted to the electric utility company's data/billing center and/or to each of the customer's premise. The data may be transmitted over one or more communications networks, including for example the Internet, to the customer's meter and/or SolarFarm reporting device or meter.

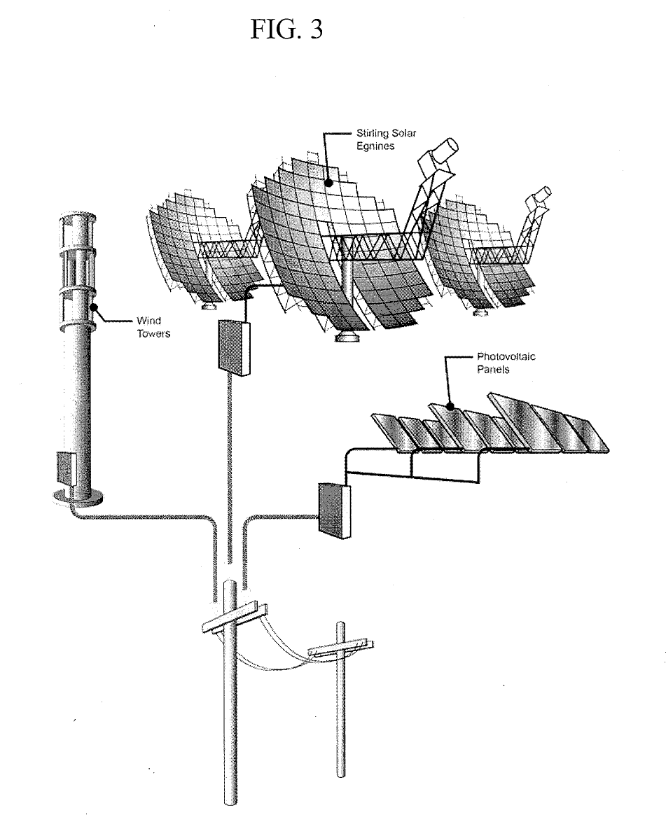

FIG. 3 depicts example contents of a SolarFarm including, without limitation, solar and wind generating facilities. Various wind energy production technologies may be used, either with individual customer modules or incremental ownership in larger wind energy production facilities.

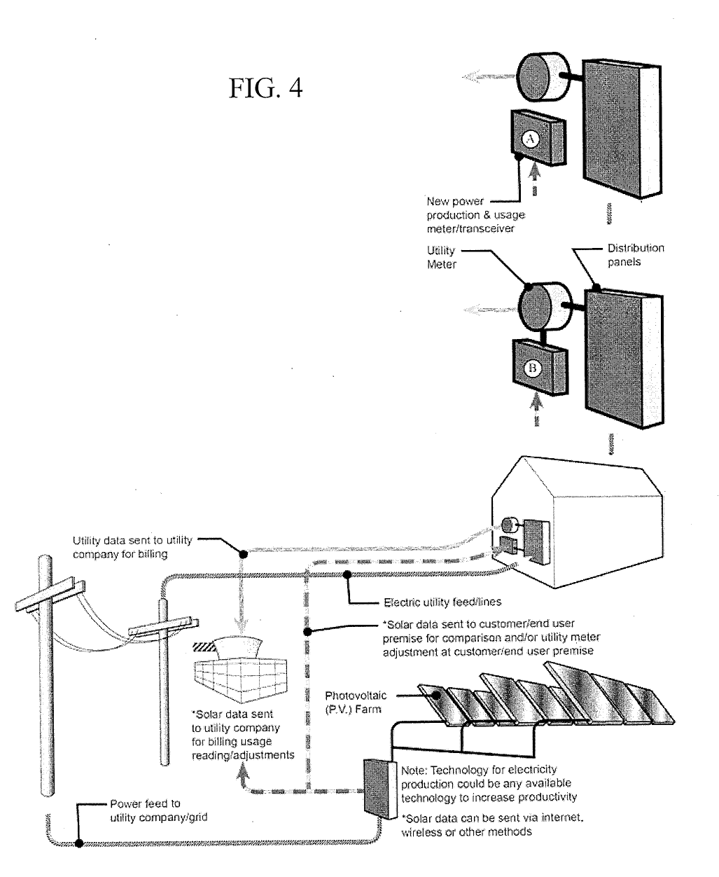

FIG. 4 depicts the SolarFarm method with reporting of each customers' energy production to the electric utility company's data/billing system for off-setting each customers billable usage or to provide a credit for each customer. Customer energy production may also be reported to customers premises and into their electric utility company's meter or adjacent to the electric utility company's meter for side-by-side usage collection for the electric utility company's billing and the associated credit for that customers' energy production supplied to the electric utility company.

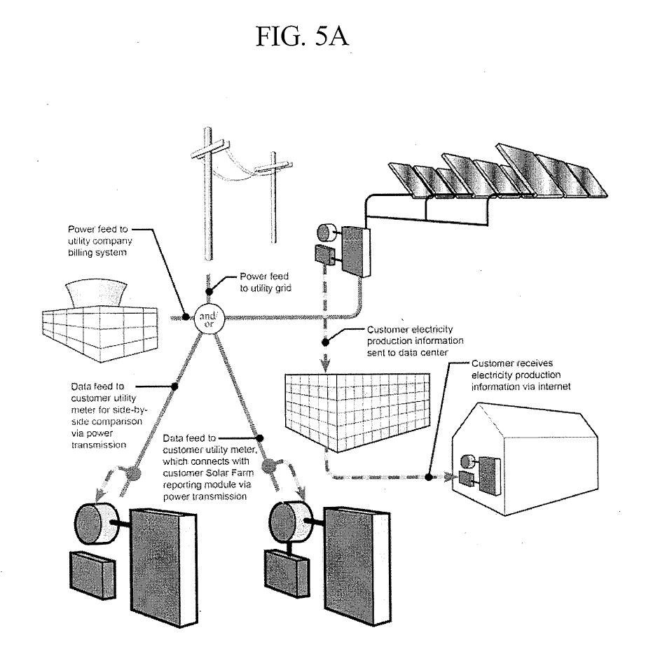

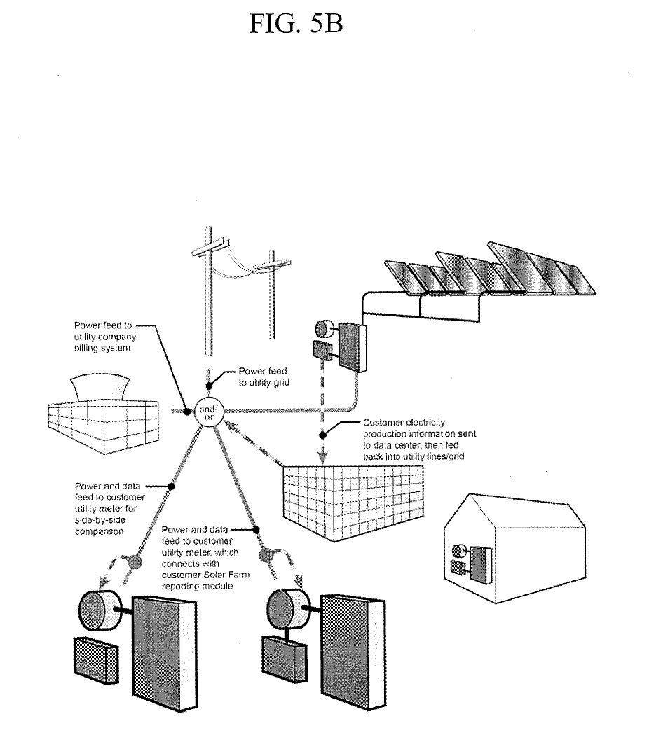

FIGS. 5A & 5B depict an approach for reporting energy production data to an electric utility company's data/billing system and/or the customer's premise (or both) via the Internet and/or over BPL technology (Broadband over Power Lines).

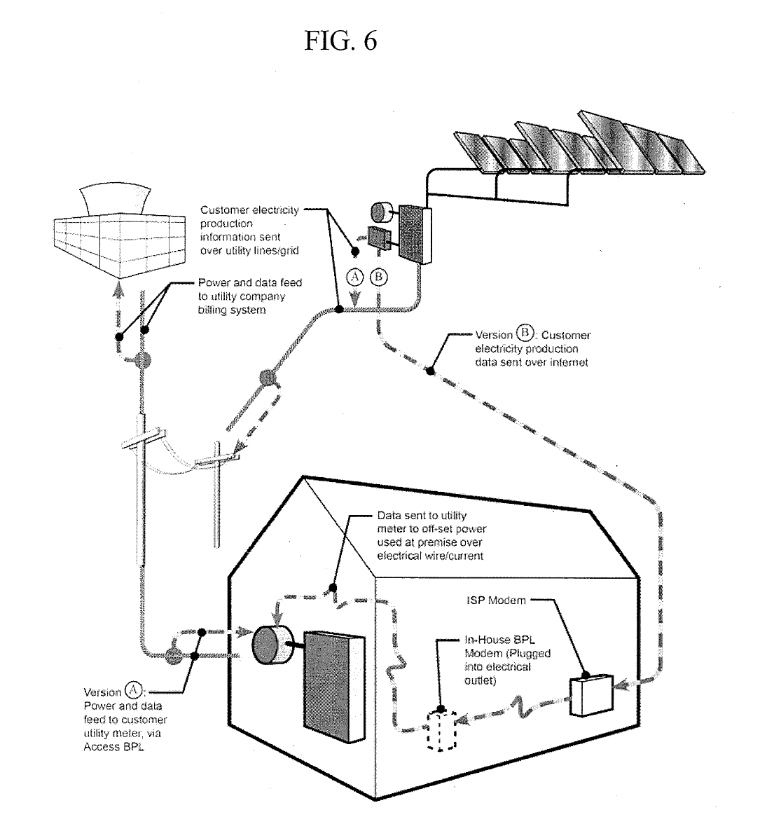

FIG. 6 depicts two example BPL methods for connecting the SolarFarm to the electric utility company and/or customer premise. With the Access BPL, data can be sent to the electric utility company from the SolarFarm over the power lines connecting SolarFarm and the electric utility company. BPL methods may also be used to report each customer's energy production to the electric utility company meter. BPL methods may also be used to report customer energy production to the SolarFarm reporting device for side-by-side reporting using the Internet to send data to the customer premise and in-house BPL to report the data to the SolarFarm reporting device in applications where Internet coverage is not sufficient to transmit data to the SolarFarm reporting device located in proximity to the electric utility company meter. The use of an in-house BPL may allow Smart Meters to directly read and adjust for the energy production data.

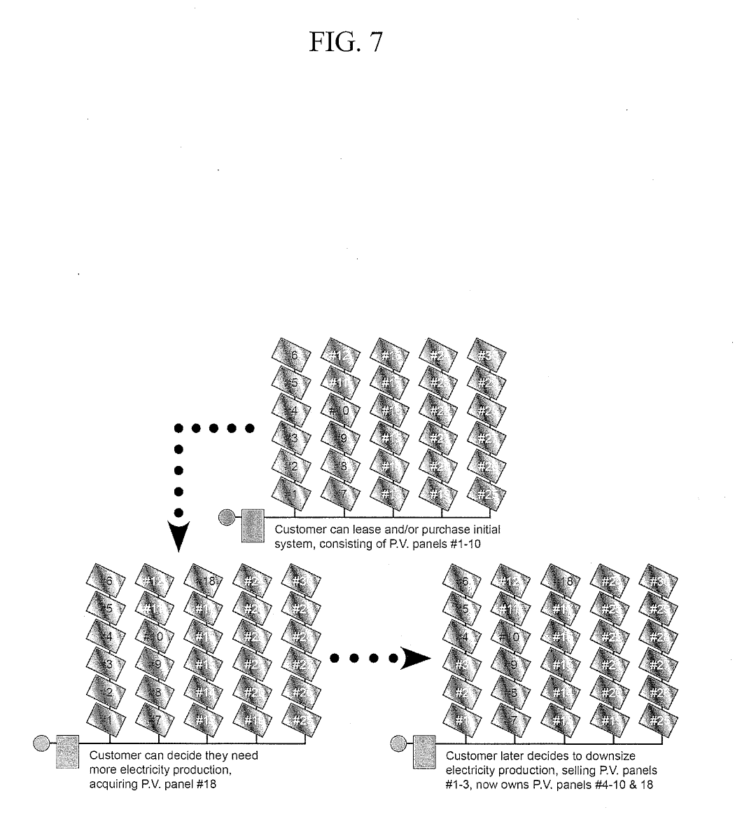

FIG. 7 depicts the modularity of the SolarFarm facility and highlights the use of photovoltaic modules with individual inverters and data reporting devices. Customers of SolarFarm may purchase incremental energy production facilities based on budget, as well as increase or decrease the capacity of their energy production facility as desired, in addition to monetizing their assets. The customer may either own the land on which the energy production facility is installed or lease the land by, for example, each photovoltaic module or as a percentage of the facility ownership.

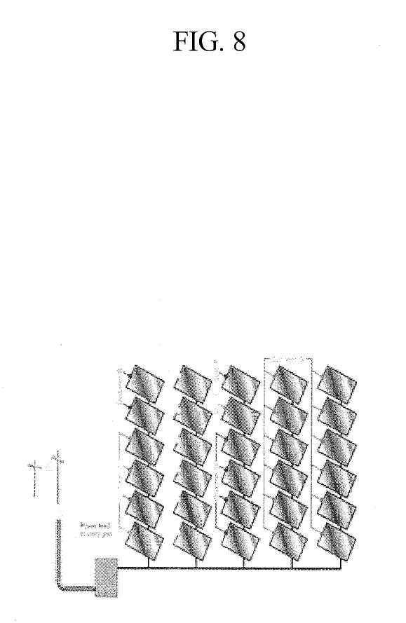

FIG. 8 depicts how individual users own a portion of a SolarFarm.

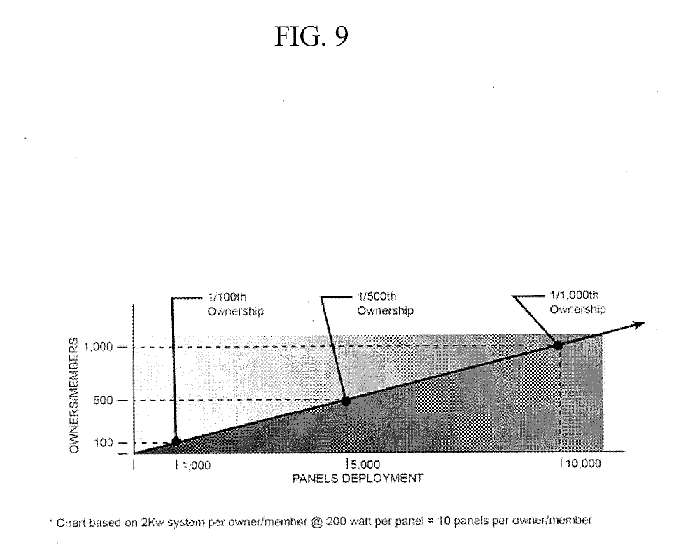

FIG. 9 depicts an example participation structure as a percentage of an energy production facility, based on their physical infrastructure ownership (i.e. photovoltaic module/panel) which changes as new customers and energy facilities are deployed within the SolarFarm. In addition, this method may include ground space compensation inclusive or separate from the physical plant/infrastructure equipment.

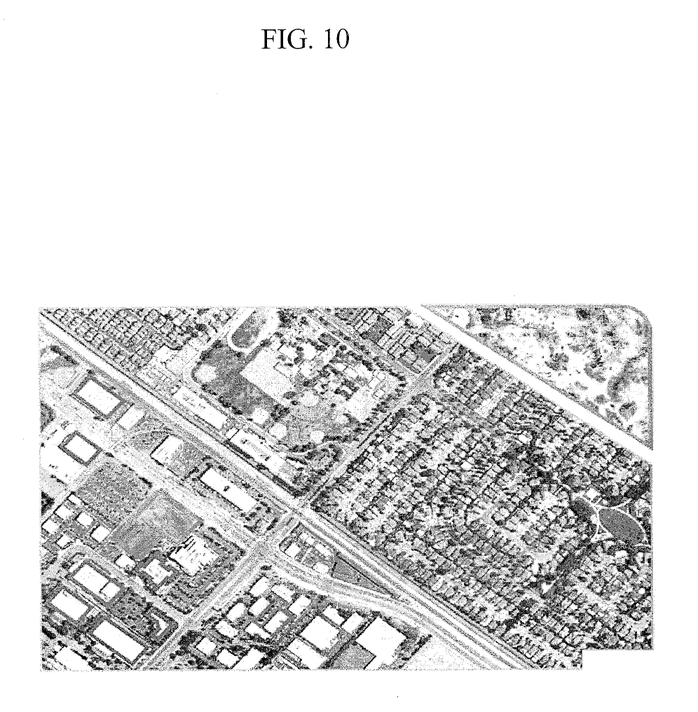

FIG. 10 depicts the placement of SolarFarm energy production facilities in various locations located in close proximity to the customer and further away from the customer premises where electricity is consumed. The approach is very practical for customers located within home owner associations where the power supplied by the electric utility is entering the community. In this situation, the electric utility does not have to increase the distribution infrastructure since the power fed into the community is already supplied over that infrastructure. Since each customer of SolarFarm is producing electricity as close as possible to their actual usage, the amount of electricity fed into the community drops due to the power supplied by each customer from the SolarFarm location. The SolarFarm facilities are located on the property of the home owner association, which may assist in compliance with various legislative and regulatory laws. This approach applies to master planned communities where master developers want to participate in generating revenue, similar to associations and others, while helping to preserve the aesthetic impact of individual home and/or business installations. Cities, shopping centers, office building owners and the like can now generate revenue from their real estate without having to become power generation facilities/utilities.

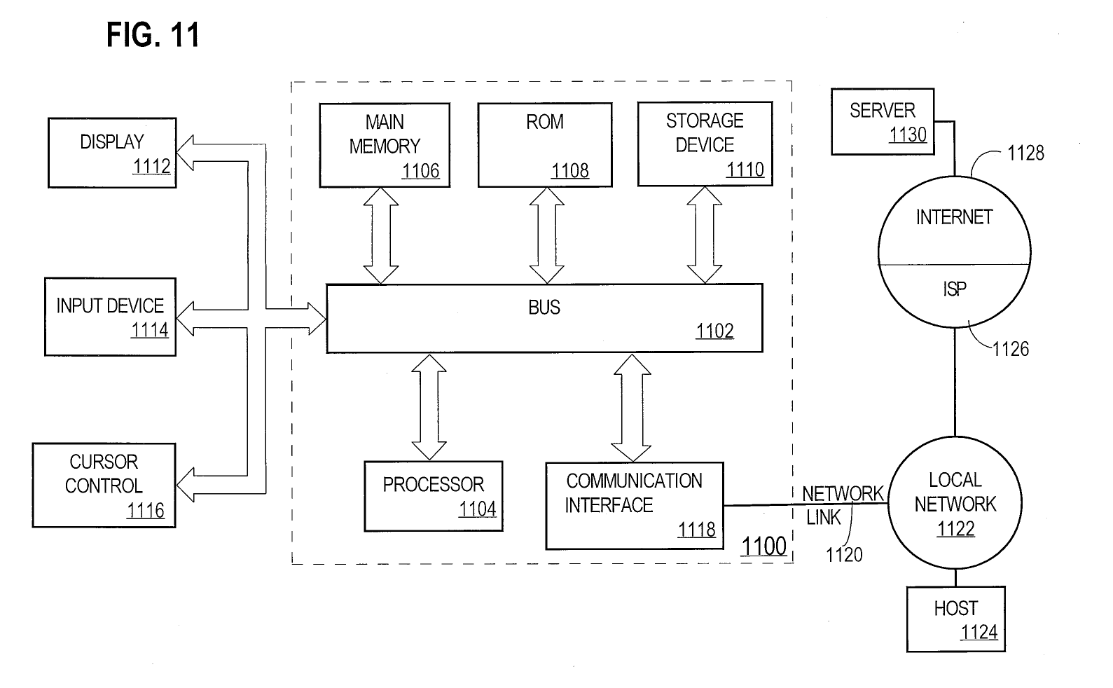

FIG. 11 is a block diagram of a computer system on which embodiments of the invention may be implemented.

### Characteristics of Conventional Solar Power Installations

Customers are limited on space, orientation to sun, climate conditions for solar electricity production, resulting in lower efficiency.
Some communities & H.O.A.'s limit and/or prohibit installation of P.V. systems.
Customer meters can “spin backwards” to offset power usage from electric utility company.
Sizing of on-site solar systems is based on pre-determined usage analysis.
Cost of installation is high based on a percentage of system cost associated with on-site construction costs, which typically average 30-60% of the system cost.
End user usually owns property

### Characteristics of SolarFarm

Energy producing facility is located off-premise
Available to everyone, not just property owners
Best production location, orientation, not limited by space, etc. (i.e. California desert)
Mobility of energy producing facility infrastructure
Productivity increased with better maintenance, repairs, etc.

### SolarFarm Structure

To take full advantage of all available technologies, a Solar Farm may include solar generating facilities, wind generating facilities and/or both.
Solar Farms may be located on land owned by a homeowners association in close proximity power usage and production. Since each homeowner owns at least a fractional share of the land owned by the homeowners association, ownership of the common grounds/parcel, each homeowner owns a portion of the SolarFarm. Ownership interest in the SolarFarm may vary between homeowners depending, for example, on their respective power usage.
SolarFarms include the capability to collect and report energy production data The energy production data indicates the energy being produced by an off-site energy production facility. The energy production data may also indicate other information, for example, the energy production attributable to particular customers/owners of the energy production facility. The energy production may be expressed in terms of energy production over time. Energy production data may be transmitted from an energy production facility to each customer/owner's location and may also be transmitted to a utility company. This allows either direct net metering at the end user's location or indirect net metering at the utility company's energy management system. The capability to collect and report energy production data may be implemented in computer hardware, computer software, or any combination of computer hardware and computer software and the approach is not limited to any particular implementation.
Energy production data may be reported using a wide variety of techniques that may vary depending upon the requirements of a particular implementation. For example, energy production data may be reported over the Internet, via one or more terrestrial, wireless or satellite-based networks and over power lines, or any combination thereof. In situations where a customer has no or limited Internet connectivity, an in-house BPL (Broadband over Power Line) or coverage repeater may be used to provide network connectivity. A BPL communications module may be integrated into, or on side of, a utility meter. A SolarFarm reporting module may be solar powered. Electricity production data may be transmitted directly to a utility meter via a utility Ethernet module and/or in-home BPL incorporated into utility smart meter. BPL allows energy production data to be sent directly to utility “Smart Meter,” side by side and “input” into utility meter. Hence, electricity production data may be generated at an off-premise energy production facility and transmitted over one or more networks to utility meters located at customer premises to allow direct offsetting of electricity. Many different types of transmission paths may be used, depending upon the requirements of a particular implementation. For example, energy production data may be transmitted over the Internet from an energy production facility to a utility company. As another example, energy production data may be transmitted over the Internet from an energy production facility to customer premises. At the customer premises, the energy production data may be transmitted over one or more networks or over power lines, e.g., using BPL, to the utility meter to provide direct offsetting of electricity. Alternatively, energy production data may be transmitted over the Internet from an energy production facility to utility meters located at customer premises. The energy production data may also be provided to other equipment at customer premises to allow customers to monitor their energy production.
Various methods may be employed to compensate an entity that establishes and manages a SolarFarm. As one example, each owner may lease their respective solar and/or wind generation equipment from an entity that establishes and manages a SolarFarm. The cost of the lease may be determined, for example, based upon the amount of land occupied by the energy generating equipment. As another example, the cost of the lease may be based upon characteristics of the energy generating equipment, such as type, size, capacity, etc. As yet another example, the amount of the lease may be based upon the amount of power generated by the energy generating equipment.
Customer/owners may also be eligible to receive state and/or federal rebates as if installed at their home and/or business.

The approach provides ownership flexibility that features:
Monetizing investment for true flexibility and efficiency.
Can utilize module specific DC to AC inverters to allow individual module production and reporting.
Data from multiple modules can be “pooled” to report customer total production.
Each customer's energy production facility is an asset that can be sold if desired. This is difficult to do when installed on customer's premise and/or when customer owns a percentage of a combined “shared” plant.
Customers energy production facilities can be kept by customers upon relocation, giving customer the ability to receive “full value” of the energy production infrastructure upon pay off for future electricity needs. Incentives in future may not be as favorable.
Customer can upgrade cost effectively in future as technology improves.
Solar Farm may charge a fee per photovoltaic panel or nominal cost per Kwh produced. A customer who purchases energy producing infrastructure may pay $1 per month (example), per photovoltaic panel to cover “rent”, cleaning, “sun tracking”, etc.
   Example SolarFarm with Individual Infrastructure Ownership with Ground Space Lease Back
According to one embodiment of invention, customers own their own energy generation equipment, but lease the land on which the energy generating equipment is installed. According to this approach, each end user acquires a number of photovoltaic panels based upon factors including, without limitation, Budget, and desired energy production, e.g., the number of desired KwH. Customer/Owners can increase and/or decrease the size of their facility.
End user is charged for incremental number of photovoltaic panels.
End user with 10 panels would pay 10 times incremental rate.
Could be paid as rent/lease or as capital contribution requirement.
Customer pays less with Solar Farm installation, lowers per watt price for quicker cost recovery if SolarFarm develops physical plant in lieu of operating as a “landlord/management” function only.
Solar Farm sells equipment at cost vs. other solar installers who dramatically mark up equipment, such as photovoltaic panels. According to the approach, an entity may sell equipment and installations at low cost with revenue being generated from land use/rent, profit sharing with home owner associations and the like. This dramatically lowers the cost of participation for SolarFarm customers.
The approach described herein reduces the number of installations and also reduces the cost of installation by providing standardized energy generating facility implementations. This is in contrast to conventional installations are typically custom installations that can require special equipment and resources, such as electrical conduit, complicated photovoltaic mounting systems and hardware, etc.
Solar Farm with cooperation of power utilities “offsets” actual customer usage at utility rate being charged to customer. This expedites cost recovery.
Cost recovery is expedited to Solar Farm system maintenance, which can increase productivity up to 20%.
Cost recovery is expedited with Solar Farm “sun tracking”, even if just occasional manual adjustments (difficult to do on residential and/or business premise installations). This can increase productivity up to 50%.
System repairs more cost effective, increasing cost recovery.
System size flexibility, ability to increase and/or decrease customers number of photovoltaic panels or others deployed technology.
Customer can upgrade/increase and/or decrease their production incrementally.

### Example Payback Analysis

1,000 Kwh Monthly Customer Use. 12,000 Kwh Annual Customer Use.
1,800 Kwh per Kw Annual. 6,667 Watt System.

| | | System Cost Per Watt | | | |
|---|---|---|---|---|---|
| Utility | Annual Kwh Off- | $9 | $7 | $5 | $3 |
| Rate | Set | $54,000 | $42,000 | $30,000 | $18,000 |
| 0.15 | $1,800 | 30 | 23 | 17 | 10 |
| 0.20 | $2,400 | 23 | 18 | 13 | 8 |
| 0.30 | $3,600 | 15 | 12 | 8 | 5 |
| 0.40 | $4,800 | 11 | 9 | 6 | 4 |

Note:
This matrix does not include the expedited payback with Depreciation Expense Included.

Example of Owner Participation
Solar Farm is setup with percentage ownership matched to photovoltaic panel count.
As system is deployed, membership percentage changes as a direct correlation to individual photovoltaic panels installed.
Allows customers to add or sell “shares/% ownership” to increase productivity/system production as needed.
Creates an asset that owners can sell in future and/or “take with them” upon relocation of business or residence.
Applicable to energy production infrastructure located in various locations, including locations close to where energy is consumed, as well as further away, including remote locations. Example locations include, without limitation, deserts, city and local municipalities, associations or other “community” lands, landfills and large industrial, commercial and retail building rooftops. These locations may provide the advantages of:
Lower cost of system installation, maintenance, etc.
Lower aesthetic impact of numerous individual systems.
Utilizes land that is not suitable for other uses, other than open space.

### Benefits of the SolarFarm Approach

No discrimination for small business, low income, elderly or the disabled.
Allows all citizens and businesses to become energy independent, not just select groups.
Many small businesses don't own their business real estate.
The cost today is too great compared to Solar Farm economies.
Businesses move, leaving behind a solar installation prior to the return on investment.
Many homeowners own condominiums, planned unit developments which eliminate opportunity to place traditional solar system.
Many homeowners don't have the space or orientation for productive solar installations.
Most homeowners have difficulty in cleaning system regularly, creates a dangerous environment with individuals climbing on their roof, especially the elderly and/or disabled.
Lower income and elderly homeowners usually reside in older homes, thus placing some P.V. panels is cost prohibitive on roofs that are older (further along in their lifespan) since the roof will need replacement prior to the end of the solar system lifespan and/or “pay back”.
Solar Farm allows everyone to have equal access to state and federal incentives while they exist, not just the wealthy and large businesses.
Solar Farm has developed the method to provide the electric utility a quantifiable means of truly allowing for customer placement of their solar production facility at another location without putting the electric utility at risk of not being fairly compensated.
Each customer's production is reported to their premise and/or to the utility for customer usage offsetting against their usage, not others.
Each customer “sizes” their energy production facility to most accurately match their usage at home and/or place of business. They are not acting as an independent power producer (utility).
In essence, the only difference is customers of Solar Farm don't have their production “hard wired” to their on-premise meter. That is the only difference. The electric utility is being provided electricity for their distribution paid for by the customer for that customer's offset/net metering of their power consumption.
Today, some homeowners and businesses can't even connect to the grid of the electric utility due to the limitations of the electric utility grid, which discriminates against those customers as well.
Many elderly, retirees and disabled (including war veterans) are on fixed income, such as Social Security.
It's not right to eliminate their opportunity to budget against ever increasing electricity rates. More of their budget to the utility, less for other life essentials.
Solar Farm eliminates some of the hardest barriers for many to become energy independent and environmental citizens doing their part, with their own money.
Public utilities have no excuse for not allowing a small change in their “billing system” and/or method of collecting consumption data reporting.
The electric company seeks tariff increases, budget for smart meters and other improvements to the electricity production and distribution by ever increasing electricity rates far beyond the cost of living index to “keep up with demand”. Now they don't have to by allowing citizens to invest in their own and our countries power production bringing in money from potentially tens of thousands of citizens, billions of dollars of economic growth and jobs without raising electricity tariffs “to meet the demand”.
Allows customer/owners the ability to earn Renewable Energy Credits (REC)s that can be transferred to utility companies as part of establishing an agreement to use the approaches described herein. RECs may help utility companies meet requirements to generate a specified percentage of their energy using renewable energy.

### Implementation Examples

According to one embodiment of the invention, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

FIG. 11 is a block diagram that depicts an example computer system 1100 upon which embodiments of the invention may be implemented. Computer system 1100 includes a bus 1102 or other communication mechanism for communicating information, and a processor 1104 coupled with bus 1102 for processing information. Computer system 1100 also includes a main memory 1106, such as a random access memory (RAM) or other dynamic storage device, coupled to bus 1102 for storing information and instructions to be executed by processor 1104. Main memory 1106 also may be used for storing temporary variables or other intermediate information during execution of instructions to be executed by processor 1104. Computer system 1100 further includes a read only memory (ROM) 1108 or other static storage device coupled to bus 1102 for storing static information and instructions for processor 1104. A storage device 1110, such as a magnetic disk or optical disk, is provided and coupled to bus 1102 for storing information and instructions.

Computer system 1100 may be coupled via bus 1102 to a display 1112, such as a cathode ray tube (CRT), for displaying information to a computer user. An input device 1114, including alphanumeric and other keys, is coupled to bus 1102 for communicating information and command selections to processor 1104. Another type of user input device is cursor control 1116, such as a mouse, a trackball, or cursor direction keys for communicating direction information and command selections to processor 1104 and for controlling cursor movement on display 1112. This input device typically has two degrees of freedom in two axes, a first axis (e.g., x) and a second axis (e.g., y), that allows the device to specify positions in a plane.

Computer system 1100 may implement the techniques described herein using customized hard-wired logic, one or more ASICs or FPGAs, firmware and/or program logic or computer software which, in combination with the computer system, causes or programs computer system 1100 to be a special-purpose machine. According to one embodiment of the invention, those techniques are performed by computer system 1100 in response to processor 1104 executing one or more sequences of one or more instructions contained in main memory 1106. Such instructions may be read into main memory 1106 from another computer-readable medium, such as storage device 1110. Execution of the sequences of instructions contained in main memory 1106 causes processor 1104 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing data that causes a computer to operation in a specific manner. In an embodiment implemented using computer system 1100, various computer-readable media are involved, for example, in providing instructions to processor 1104 for execution. Such a medium may take many forms, including but not limited to, non-volatile media and volatile media. Non-volatile media includes, for example, optical or magnetic disks, such as storage device 1110. Volatile media includes dynamic memory, such as main memory 1106. Common forms of computer-readable media include, for example, a floppy disk, a flexible disk, hard disk, magnetic tape, or any other magnetic medium, a CD-ROM, any other optical medium, a RAM, a PROM, and EPROM, a FLASH-EPROM, any other memory chip or memory cartridge, or any other medium from which a computer can read.

Various forms of computer-readable media may be involved in carrying one or more sequences of one or more instructions to processor 1104 for execution. For example, the instructions may initially be carried on a magnetic disk of a remote computer. The remote computer can load the instructions into its dynamic memory and send the instructions over a telephone line using a modem. A modem local to computer system 1100 can receive the data on the telephone line and use an infra-red transmitter to convert the data to an infra-red signal. An infra-red detector can receive the data carried in the infra-red signal and appropriate circuitry can place the data on bus 1102. Bus 1102 carries the data to main memory 1106, from which processor 1104 retrieves and executes the instructions. The instructions received by main memory 1106 may optionally be stored on storage device 1110 either before or after execution by processor 1104.

Computer system 1100 also includes a communication interface 1118 coupled to bus 1102. Communication interface 1118 provides a two-way data communication coupling to a network link 1120 that is connected to a local network 1122. For example, communication interface 1118 may be an integrated services digital network (ISDN) card or a modem to provide a data communication connection to a corresponding type of telephone line. As another example, communication interface 1118 may be a local area network (LAN) card to provide a data communication connection to a compatible LAN. Wireless links may also be implemented. In any such implementation, communication interface 1118 sends and receives electrical, electromagnetic or optical signals that carry digital data streams representing various types of information.

Network link 1120 typically provides data communication through one or more networks to other data devices. For example, network link 1120 may provide a connection through local network 1122 to a host computer 1124 or to data equipment operated by an Internet Service Provider (ISP) 1126. ISP 1126 in turn provides data communication services through the world wide packet data communication network now commonly referred to as the “Internet” 1128. Local network 1122 and Internet 1128 both use electrical, electromagnetic or optical signals that carry digital data streams.

Computer system 1100 can send messages and receive data, including program code, through the network(s), network link 1120 and communication interface 1118. In the Internet example, a server 1130 might transmit a requested code for an application program through Internet 1128, ISP 1126, local network 1122 and communication interface 1118. The received code may be executed by processor 1104 as it is received, and/or stored in storage device 1110, or other non-volatile storage for later execution. In the foregoing specification, embodiments of the invention have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method for allocating off premises electricity production to a plurality of end users as substantially described and depicted herein.
